(19) United States
(12) Patent Application Publication
(10) Pub. No.: US 2013/0062137 A1
(43) Pub. Date: Mar. 14, 2013

(54) Electric Power Steering System

(71) Applicant: Haruaki MOTODA, Isesaki-shi (JP)

(72) Inventor: Haruaki MOTODA, Isesaki-shi (JP)

(73) Assignee: Hitachi Automotive Systems, Ltd., Hitachinaka-shi (JP)

(21) Appl. No.: 13/597,587

(22) Filed: Aug. 29, 2012

(30) Foreign Application Priority Data
Sep. 14, 2011 (JP) 2011-200058
Sep. 14, 2011 (JP) 2011-200059

(51) Int. Cl. B62D 5/04; B62D 6/08

(52) U.S. Cl. 180/446

(57) ABSTRACT

An electric power steering system has an electric motor that is housed in a motor housing having a cylindrical portion and provides a steering assist force to a steering shaft; a control unit that controls the electric motor and has an ECU housing located on an opposite side to an output shaft of the electric motor in an axial direction of the motor housing; a power conversion circuit housed in the ECU housing and having a semiconductor switch for controlling the electric motor; and a control circuit housed in the ECU housing and controlling the semiconductor switch. The electric power steering system also has a conductive member that electrically connects an output terminal of the semiconductor switch and an input terminal of the electric motor. Part of a metal board of the conductive member is contiguous to an inner surface of the motor housing or of the ECU housing.

### BACKGROUND OF THE INVENTION

The present invention relates to an electric power steering system having an electric motor that generates a steering assist torque and a control unit that controls the electric motor.

The electric power steering system for a vehicle is configured so that, a turning direction and a turning torque of a steering shaft that turns by driver's steering wheel operation are detected, and on the basis of these detection values the electric motor is driven so as to rotate in the same direction as the turning direction of the steering shaft, then the steering assist torque is generated. The electric power steering system is provided with the control unit (ECU: Electronic Control Unit) to control this electric motor.

As a control unit of a related art electric power steering system, for instance, it is disclosed in Japanese Patent Provisional Publication No. 2010-269693 (hereinafter is referred to as “JP2010-269693”). The electric power steering system disclosed in JP2010-269693 has, as shown in FIG. 1 in JP2010-269693, an electric motor 101 that outputs an assist torque, a speed reduction gear 112 that has a worm gear 114 and a worm wheel 115 to reduce a rotation speed of the electric motor 101, and a controller 120 that controls drive of the electric motor 101. The controller 120 has a semiconductor switching element 121, a circuit board 122, a conductive board 123 and a cover member 124. In JP2010-269693, by arranging the controller 120 between the electric motor 101 and the speed reduction gear 112, size reduction of the electric power steering system is achieved.

### SUMMARY OF THE INVENTION

In JP2010-269693, however, an end portion of an armature winding 109 of the electric motor 101 is welded to a connection terminal 110, and the connection terminal 110 is connected to the circuit board 122. On the other hand, the semiconductor switching element 121 which is an element that generates heat is connected to the circuit board 122 through the conductive board 123, and the semiconductor switching element 121 is fixed to an inner surface of the cover member 124 through a heat spreader 129 for heat radiation.

Because of this configuration, heat that is generated in the armature winding 109 of the electric motor 101 is transferred to the semiconductor switching element 121 through the connection terminal 110, the circuit board 122 and the conductive board 123. That is, heat of the armature winding 109 is conducted to the semiconductor switching element 121. As a consequence, the heat conducted from the armature winding 109 to the semiconductor switching element 121 and heat which the semiconductor switching element 121 generates are added, this added heat is then conducted to a gear case 113 through the heat spreader 129 and the cover member 124, and radiates from an outside surface of the gear case 113 into the atmosphere.

Since the heat of the armature winding 109 is conducted to the gear case 113 through the semiconductor switching element 121 of the heat-generating element, heat radiation of the semiconductor switching element 121 and the electric motor 101 is not adequately performed.

Further, since the heat from the armature winding 109 radiates from the gear case 113 that acts as a radiation part of the semiconductor switching element 121, large thermal mass of the gear case 113 is required, and the gear case 113 might increase in size.

It is therefore an object of the present invention to provide an electric power steering system that is capable of adequately performing the heat radiation of the control unit and the electric motor.

According to one aspect of the present invention, an electric power steering system comprises: an electric motor that is housed in a motor housing having a cylindrical portion and provides a steering assist force to a steering shaft; a control unit that controls the electric motor and has an ECU housing located on an opposite side to an output shaft of the electric motor in an axial direction of the motor housing; a power conversion circuit housed in the ECU housing and having a semiconductor switch for controlling drive of the electric motor; and a control circuit housed in the ECU housing and controlling the semiconductor switch; and a conductive member that electrically connects an output terminal of the semiconductor switch and an input terminal of the electric motor, and part of a metal board of the conductive member is contiguous to an inner surface of the motor housing or of the ECU housing.

According to another aspect of the present invention, an electric power steering system comprises: an electric motor that is housed in a motor housing having a cylindrical portion and provides a steering assist force to a steering shaft; a control unit that controls the electric motor and has an ECU housing located on an opposite side to an output shaft of the electric motor in an axial direction of the motor housing; a power conversion circuit housed in the ECU housing and having a semiconductor switch for controlling drive of the electric motor; and a control circuit housed in the ECU housing and controlling the semiconductor switch; a conductive member that electrically connects an output terminal of the semiconductor switch and an input terminal of the electric motor; and a motor relay that is configured by a semiconductor element and applies power to the electric motor or stops the power, and part of a metal board of the conductive member is contiguous to an inner surface of the motor housing, and the motor relay is mounted on the conductive member.

The other objects and features of this invention will become understood from the following description with reference to the accompanying drawings.

### BRIEF DESCRIPTION OF THE DRAWINGS

FIG. 1 is a perspective view showing a key part of an electric power steering system of the present invention with a retaining member removed.

FIG. 2 is a perspective view showing the key part of the electric power steering system of the present invention.

FIG. 3 is a sectional view of the electric power steering system.

FIG. 4 is an enlarged sectional view of the key part of the electric power steering system.

FIG. 5 is a perspective view showing an outward appearance of the electric power steering system.

FIGS. 6A and 6B are drawings that explain a heat conducting state (a conducting direction of heat and a conducting amount of heat) in the electric power steering system. FIG. 6A is a case of a related art electric power steering system, FIG. 6B is a case of the present invention.

FIGS. 7A and 7B are drawings that show a temperature change of each element or component in the electric power steering system. FIG. 7A is a case of the related art electric power steering system, FIG. 7B is a case of the present invention.

FIG. 8 is a drawing that shows a cantilever structure of an electric motor (shows that the electric motor is fixed and supported at only one side).

### DETAILED DESCRIPTION OF THE INVENTION

According to the present invention, heat that is generated in an armature winding of an electric motor is conducted to a motor housing or an ECU housing from an input terminal of the armature winding through a conductive member and an insulating layer, and radiates from an outside of the housing into the atmosphere.

According to the present invention, heat that is generated in a motor relay is also conducted to the motor housing through the conductive member, and radiates from the outside of the motor housing into the atmosphere.

Embodiments of an electric power steering system of the present invention will now be explained below with reference to the drawings.

[Configuration]

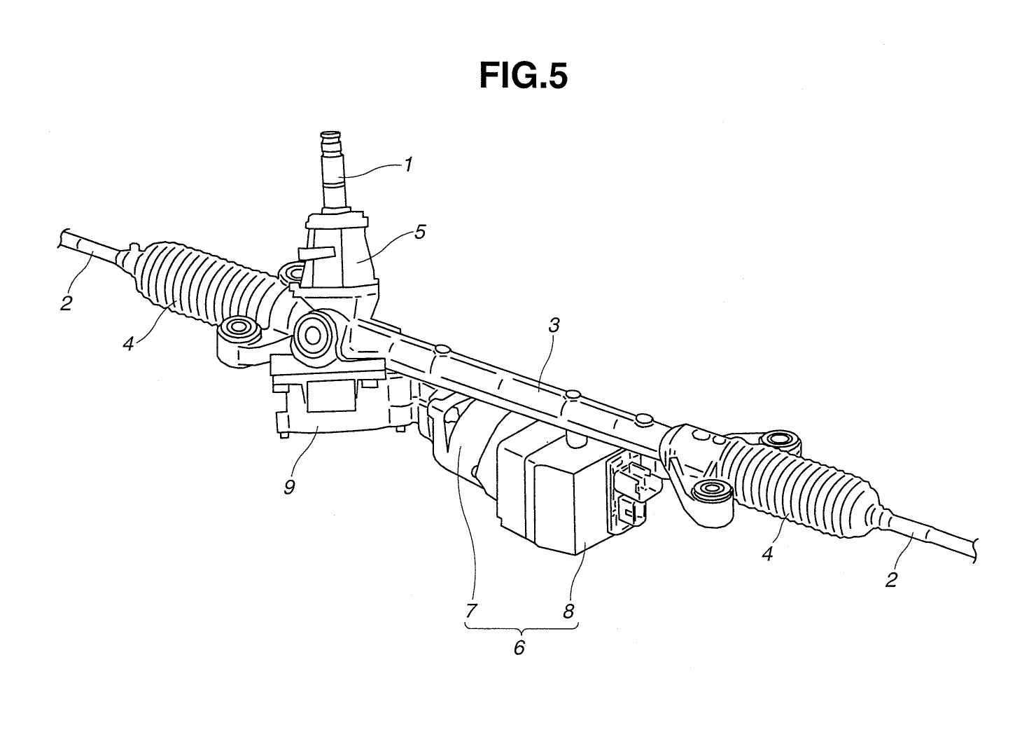

A steering mechanism to steer front wheels of a vehicle is shown in FIG. 5. A pinion (not shown) is provided at a lower end of a steering shaft 1 that is connected to a steering wheel (not shown), and the pinion is engaged with a rack (not shown) that extends in a right-and-left direction of the vehicle. Tie rods 2 for steering the front wheels in right and left directions are linked to both ends of the rack respectively. The rack is covered with a rack housing 3. Between the rack housing 3 and each tie rod 2, a rubber boot (an elastic boot) 4 is provided.

An electric power steering system 6 is provided to assist driver's steering effort by providing torque upon a turning operation of the steering wheel. That is, the electric power steering system 6 has a torque sensor 5 that detects a turning direction and a turning torque of the steering shaft 1, an electric motor 7 that provides a steering assist force to the steering shaft 1 on the basis of a detection value of the torque sensor 5, and a control unit (ECU) 8 that controls the electric motor 7.

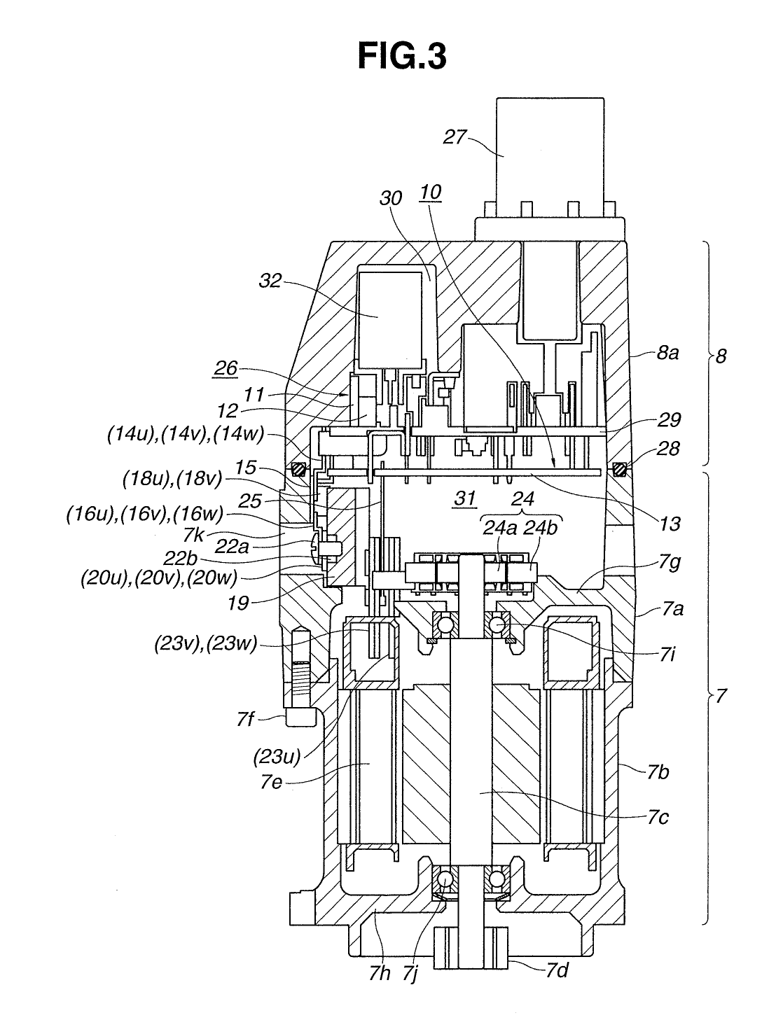

As shown in FIG. 3, the electric motor 7 is housed in motor housings 7a, 7b having a cylindrical portion. The motor housing 7a and the motor housing 7b are stacked up in an axial direction, and combined together with hexagon socket head cap screws 7f. A division wall (or a bulkhead) 7g is formed in the motor housing 7a, while a division wall (or a bulkhead) 7h is formed in the motor housing 7b. The division walls 7g, 7h are provided with bearings 7i, 7j respectively, and an output shaft 7c of the electric motor 7 is rotatably supported by these bearings 7i, 7j. The output shaft 7c is provided, at a top end thereof, with a pinion 7d. The pinion 7d is connected to the steering shaft 1 through a part of a gear 9 shown in FIG. 5. A gear housing of this gear 9 is formed integrally with the rack housing 3.

The control unit 8 has an ECU housing 8a, a power conversion circuit (or a power inverter circuit) 26 and a control circuit 10.

The ECU housing 8a is located on an opposite side to the output shaft 7c of the electric motor 7 in the axial direction of the motor housings 7a, 7b. Between the motor housing 7a and the ECU housing 8a, an O-ring 28 is provided. This ECU housing 8a serves also as an ECU heat sink for cooling an after-mentioned MOSFET 12. In the ECU housing 8a, a partition wall 29 is provided to partition an inside of the ECU housing 8a into two sides in the axial direction. In FIG. 3, a power conversion room 30 is defined on an upper side of the partition wall 29, while a control room 31 is defined from the inside of the ECU housing 8a on a lower side of the partition wall 29 to an inside of the motor housing 7a.

The power conversion room 30 houses therein the power conversion circuit 26. The power conversion circuit 26 is configured by mounting the MOSFET 12, which functions as a semiconductor switch to control the drive of the electric motor 7, on a first metal circuit board 11. A reference sign 32 is an aluminum capacitor.

The control room 31 houses therein the control circuit 10. The control circuit 10 controls the MOSFET 12 etc., and is configured by mounting electronic elements or components on a printed board 13 that is set at a boundary position between the motor housing 7a and the ECU housing 8a.

A reference sign 27 is a connecter that is connected to a battery (not shown). Power is then supplied to the power conversion circuit 26 and the control circuit 10 via this connecter 27.

The control room 31 is provided with a heat radiation mechanism to radiate heat that is generated in an armature winding 7e of the electric motor 7 from an outside surface of the motor housing 7a.

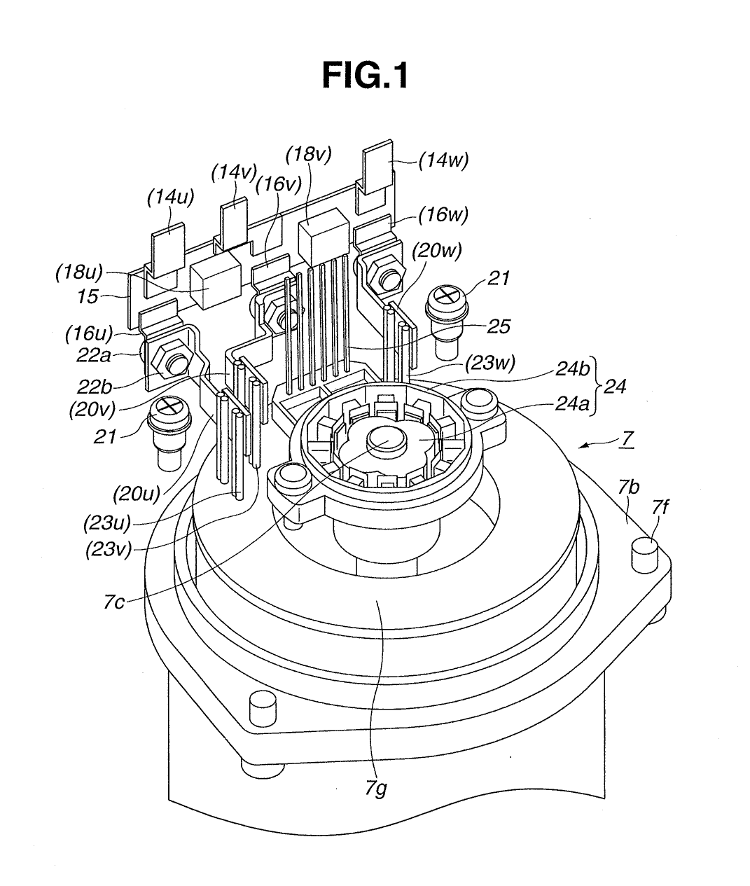

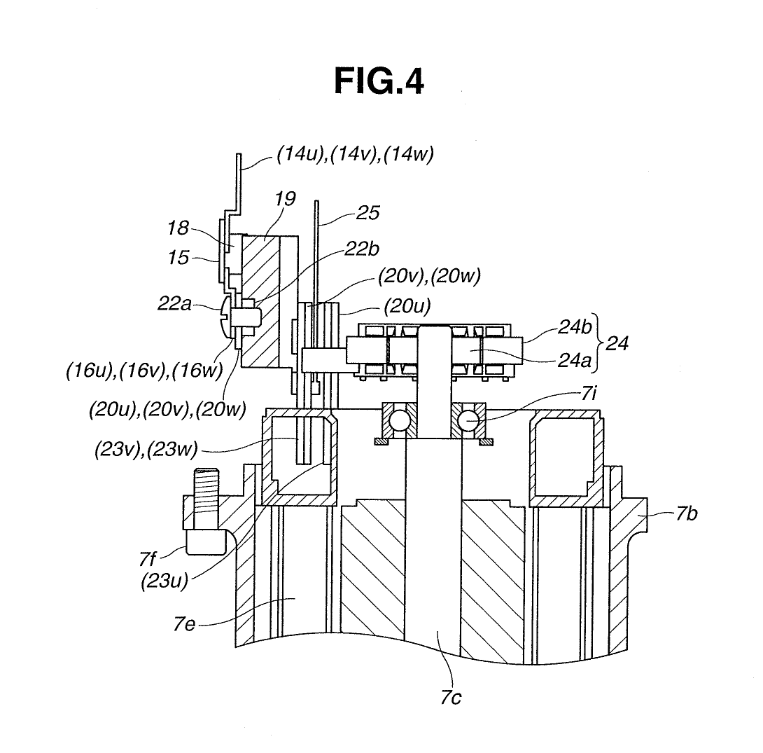

FIG. 4 is an enlarged sectional view of part of the heat radiation mechanism shown in FIG. 3. Also each components in FIG. 4 is shown by a perspective view in FIG. 1. As shown in the drawings, output terminals 14u, 14v, 14w of the MOSFET 12 of the semiconductor switch and input terminals 16u, 16v, 16w of the electric motor 7 are electrically connected to a second metal circuit board 15 as a current-carrying member (or a conductive member). Here, the conductive member means a member in which an insulating layer is formed on a metal board, and a wiring part that forms a circuit is formed on the insulating layer. Both of the first metal circuit board 11 and the second metal circuit board 15 are configured by forming the insulating layer on an aluminum board and printing a wiring pattern of copper foil on the insulating layer.

As is clear from FIG. 1, the output terminals 14u, 14v, 14w of the MOSFET 12 are connected to one side (an upper side) of the second metal circuit board 15, while the input terminals 16u, 16v, 16w of the electric motor 7 are connected to the other side (a lower side) of the second metal circuit board 15. Each of these input and output terminals is electrically connected to the wiring pattern on the second metal circuit board 15.

Two motor relays 18u, 18v are mounted on the second metal circuit board 15. These motor relays 18u, 18v are configured by a semiconductor element that applies power or stops the power.

Next, electrical connection of the motor relays 18u, 18v will be explained. The motor relay 18u is connected between the output terminal 14u of the MOSFET 12 as the semiconductor switch and the input terminal 16u of the electric motor 7 through the wiring pattern on the second metal circuit board 15. On the other hand, the motor relay 18v is connected between the output terminal 14v of the MOSFET 12 as the semiconductor switch and the input terminal 16v of the electric motor 7 through the wiring pattern on the second metal circuit board 15. The output terminal 14w of the MOSFET 12 as the semiconductor switch and the input terminal 16w of the electric motor 7 are directly connected without intervention of the motor relay.

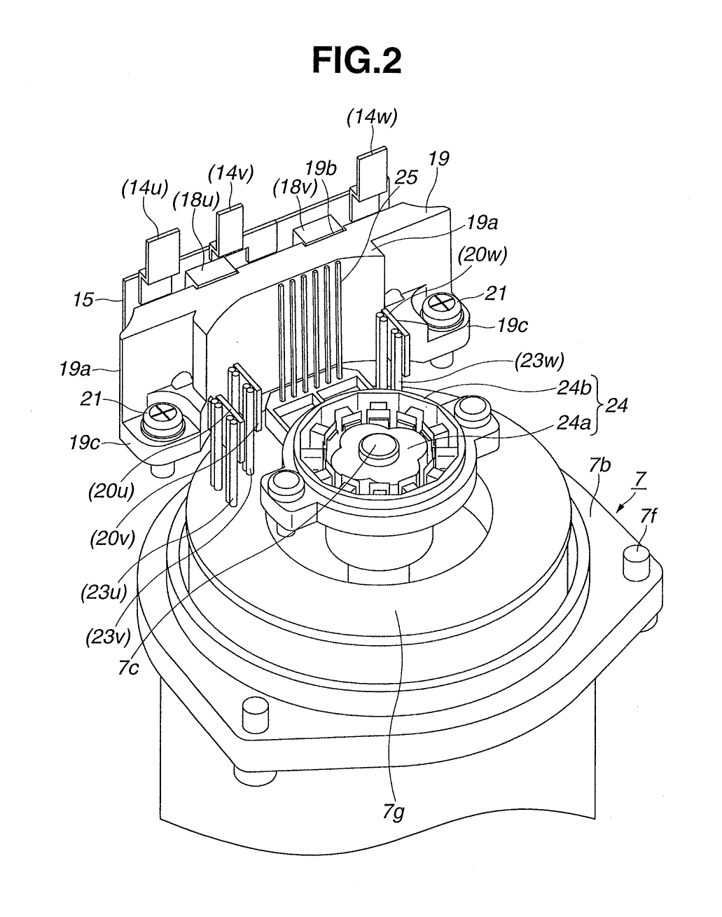

With regard to the second metal circuit board 15 on which the motor relays 18 (18u, 18v) are mounted, the second metal circuit board 15 is retained with a part (a surface) of the aluminum board of the second metal circuit board 15 pressed against an inner surface of the motor housing 7a. More specifically, in order to press the surface of the aluminum board of the second metal circuit board 15 against the inner surface of the motor housing 7a, as shown in FIG. 2, a retaining member 19 is provided. The retaining member 19 is a member in which three connecting metals (or connecting clamps) 20u, 20v, 20w that extend in a horizontal direction, shown in FIG. 1, are molded or covered by resin as an insulating material.

As shown in FIG. 2, the retaining member 19 is formed into a plate shape that extends along the axial direction. The retaining member 19 has, on one side thereof, two protruding portions 19a to secure a wiring space for after-mentioned resolver signal terminals 25, also has, on the other side thereof, two recessed portions 19b into which the motor relays 18u, 18v are fitted. Further, the retaining member 19 has, at a lower part thereof, fixing seats 19c that protrude in the horizontal direction. By inserting screws 21 into respective fixing holes formed at the fixing seats 19c and screwing the screws 21 onto the division wall 7g of the motor housing 7a, the retaining member 19 is fixed to the motor housing 7a. With this fixing, the second metal circuit board 15 is pressed against the inner surface of the motor housing 7a with the second metal circuit board 15 sandwiched between the retaining member 19 and the motor housing 7a.

End portions 23u, 23v, 23w of the armature winding 7e of the electric motor 7 lead to an opposite side to the pinion 7d of the output shaft 7c along the axial direction and penetrate the division wall 7g. These end portions 23u, 23v, 23w of the armature winding 7e are then welded to one side edges, at a radially inward side, of the respective resin-molded connecting clamps 20u, 20v, 20w. Further, the other side edges, at a radially outward side, of the three resin-molded connecting clamps 20u, 20v, 20w are connected to lower ends of the input terminals 16u, 16v, 16w of the electric motor 7 respectively with a screw (or a bolt) 22a and a nut 22b. Here, in order to be able to screw the screw 22a from outside of the motor housing 7a, a working opening (or three working openings) 7k that penetrates the motor housing 7a is formed in the motor housing 7a (see FIG. 3).

In FIGS. 1 to 4, a reference sign 24 is a resolver. A reference sign 24a is a rotor secured to the output shaft 7c of the electric motor 7, and a reference sign 24b is a stator fixed to the division wall 7g and detecting a rotation speed of the rotor 24a. In order to send signals of the rotation speed of the output shaft 7c detected by the resolver 24 to the control circuit 10, six resolver terminals 25 that connect the resolver 24 and the printed board 13 are disposed in the axial direction.

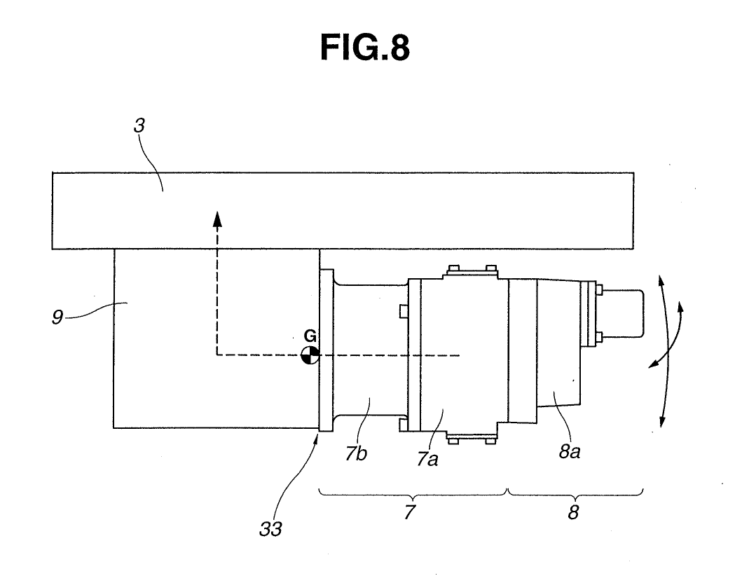

Structure of the electric motor 7, the control unit 8 and the gear 9 shown in FIG. 5 is shown in FIG. 8. As can be seen in FIG. 8, the electric motor 7 is fixed and supported at only its one side. That is, one end at the output shaft 7c side of the motor housing 7b is joined to the gear housing of the gear 9 forming the steering mechanism with a bolt (or bolts, not shown), then the electric motor 7 has a cantilever structure. A barycentric position (a position of the center of gravity) of the electric motor 7 in the cantilever structure is positioned close to a joining part 33 of the gear 9 and the motor housing 7b. A free end side (a control unit 8 side) of the electric motor 7 having the cantilever structure rocks or oscillates in all directions of vertical and horizontal directions as shown by arrows in FIG. 8.

[Operation]

Next, operation of the electric power steering system will be explained.

When the steering shaft 1 is operated and turns in a certain turning direction by driver's steering wheel operation, the torque sensor 5 detects the turning direction and the turning torque of the steering shaft 1. The control circuit 10 calculates a drive operation amount of the electric motor 7 on the basis of the detection value, then the electric motor 7 is driven by the MOSFET 12 of the power conversion circuit 26 on the basis of this calculated value. The output shaft 7c of the electric motor 7 rotates so as to drive or turn the steering shaft 1 in the same direction as an operating direction of the steering shaft 1, and this rotation of the output shaft 7c is transmitted, as a steering assist torque, to the steering shaft 1 from the pinion 7d through the gear 9 shown in FIG. 5.

According to this embodiment, the heat generated in the armature winding 7e of the electric motor 7 is conducted to the input terminals 16u, 16v, 16w from the end portions 23u, 23v, 23w of the armature winding 7e through the connecting clamps 20u, 20v, 20w, and further conducted to the motor housing 7a from the input terminals 16u, 16v, 16w through the second metal circuit board 15 and the insulating layer. The heat then radiates from the outside (the outside surface) of the motor housing 7a into the atmosphere, and further is conducted to the gear 9 too from the motor housing 7a through the motor housing 7b as shown by a broken line in FIG. 8.

Not only the heat generated in the armature winding 7e but heat that is generated in the motor relays 18u, 18v of the semiconductor elements is also conducted to the motor housing 7a through the second metal circuit board 15. As same as the heat radiation of the heat generated in the armature winding 7e, this heat radiates from the outside (the outside surface) of the motor housing 7a into the atmosphere, and further is conducted to the gear 9 too from the motor housing 7a through the motor housing 7b as shown by the broken line in FIG. 8.

On the other hand, heat generated in the MOSFET 12 is conducted to the ECU housing 8a through the first metal circuit board 11, then radiates from an outside (an outside surface) of the ECU housing 8a into the atmosphere.

In the electric power steering system, the heat generated in the armature winding 7e of the electric motor 7 is conducted to the motor housing 7a through the input terminals 16u, 16v, 16w and the second metal circuit board 15, and radiates from the outside (the outside surface) of the motor housing 7a into the atmosphere, or is conducted to the gear 9 too from the motor housing 7a through the motor housing 7b. Efficiency of the heat radiation of the electric motor 7 is thus increased. Furthermore, conduction of the heat generated in the armature winding 7e of the electric motor 7 to the MOSFET 12 as the semiconductor switch through the output terminals 14u, 14v, 14w is suppressed.

In the electric power steering system, the heat generated in the motor relays 18u, 18v of the semiconductor elements is conducted to the motor housing 7a through the second metal circuit board 15, and radiates from the outside (the outside surface) of the motor housing 7a into the atmosphere, or is conducted to the gear 9 too from the motor housing 7a through the motor housing 7b. Efficiency of the heat radiation of the motor relays 18u, 18v is thus increased. In addition, the motor relays 18u, 18v are separated from the control unit 8 and fixed to the second metal circuit board 15, and the second metal circuit board 15 is housed in the motor housing 7a. This consequently reduces a heat generation amount of the control unit 8.

Further, since the motor relays 18u, 18v are configured by the semiconductor element, the heat is easily conducted to the second metal circuit board 15 and the motor housing 7a as compared with a mechanical relay in which structurally heat is apt to accumulate, and also the heat is hard to be conducted to the MOSFET 12. As a consequence, temperature increase of the control unit 8 is suppressed.

Moreover, normally the motor relays 18u, 18v are housed in the ECU housing 8a. However, in the present embodiment, the motor relays 18u, 18v are housed in the motor housing 7a. Therefore, although the electric motor 7 increases in size in the axial direction, the control unit 8 can decrease in size in a radial direction.

In the electric power steering system, while the heat generated in the armature winding 7e of the electric motor 7 is conducted to the motor housing 7a, the heat generated in the MOSFET 12 is conducted to the ECU housing 8a, then these heat separately radiates from the outsides of the different housings into the atmosphere. This gives rise to high efficiency of the heat radiation. In other words, since the heat is conducted to and radiates from the different housings, appropriate heat radiation can be achieved without having to increase thermal mass of the housing.

According to this embodiment, since the second metal circuit board 15 is pressed against the inner surface of the motor housing 7a, the second metal circuit board 15 and the motor housing 7a are stuck firmly, thus the heat is conducted efficiently from the second metal circuit board 15 to the motor housing 7a. Further, since it is possible to suppress an occurrence of stress caused by vibration of the vehicle at a connecting part (a soldered connection) between the output terminals 14u, 14v, 14w of the MOSFET 12 and the second metal circuit board 15, reliability of the connecting part is improved.

In the electric power steering system, since the second metal circuit board 15 and the motor housing 7a are stuck firmly, the heat is conducted efficiently from the second metal circuit board 15 to the motor housing 7a, and the heat generated in the armature winding 7e of the electric motor 7 efficiently radiates from the outside (the outside surface) of the motor housing 7a into the atmosphere. Also the heat generated in the motor relays 18u, 18v efficiently radiates from the outside (the outside surface) of the motor housing 7a into the atmosphere, or is conducted to the gear 9 too from the motor housing 7a through the motor housing 7b.

In addition, by the fact that the second metal circuit board 15 is retained with the second metal circuit board 15 pressed against the motor housing 7a by the retaining member 19, the second metal circuit board 15 is firmly fixed to the motor housing 7a, thereby increasing fixability (reliability and workability of the fixing) of the second metal circuit board 15.

In the electric power steering system, since the motor relays 18u, 18v are configured by the semiconductor element, the heat generated in the semiconductor element is conducted to the motor housing 7a through the second metal circuit board 15, and radiates from the outside (the outside surface) of the motor housing 7a into the atmosphere, or is conducted to the gear 9 too from the motor housing 7a through the motor housing 7b. Hence, the efficiency of the heat radiation is higher than that of the mechanical relay in which structurally heat is apt to accumulate, this suppresses the temperature increase in the motor housing 7a.

According to this embodiment, as shown in FIG. 8, the motor relays 18u, 18v are provided and positioned inside the motor housing 7a that is located at a closer position to the joining part 33 of the motor housing 7b and the housing of the gear 9 of the steering mechanism with respect to the ECU housing 8a. Thus the barycentric position of the electric motor 7 is close to the joining part 33, and the electric motor 7 having the cantilever structure is less prone to rock or oscillate.

In the electric power steering system, the second metal circuit board 15 to which the motor relays 18u, 18v are fixed is not housed in the ECU housing 8a, but housed in the motor housing 7a. In consequence, since the motor relays 18u, 18v are located at a closer position to the joining part 33 of the electric motor 7 having the cantilever structure, the motor relays 18u, 18v are close to the position G (shown in FIG. 8) of the center of gravity of the electric motor 7, and rocking movement or oscillation of the electric motor 7 can be suppressed.

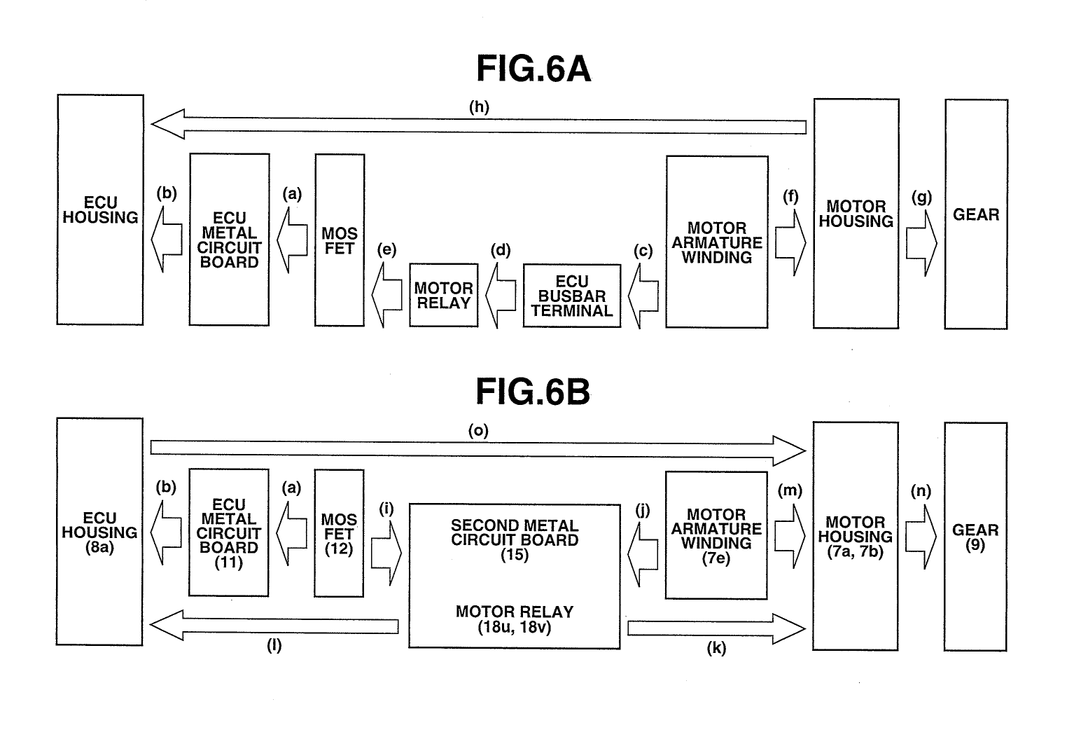

Here, heat conducting states, i.e. conducting directions and conducting amounts of the heat generated in the MOSFET 12 as the semiconductor switch and generated in the armature winding 7e of the electric motor 7, are shown in FIGS. 6A and 6B. FIG. 6A is a case of a related art electric power steering system. FIG. 6B is a case of the present embodiment.

As shown by arrows (a) and (b), there is no large difference between the related art electric power steering system and the present embodiment in the conduction of the heat generated in the MOSFET 12 to the ECU housing (the ECU heat sink) 8a through the first metal circuit board 11. However, with regard to the heat generated in the armature winding of the electric motor, in the case of the related art electric power steering system, as shown by arrows (c), (d) and (e) in FIG. 6A, much heat of the armature winding of the electric motor flows to the MOSFET through an ECU busbar terminal and the motor relay. Also the heat generated in the motor relay flows to the MOSFET as shown by the arrow (e). A part of the residual heat is conducted to the gear through the motor housing as shown by arrows (f) and (g). In addition, as shown by an arrow (h), the heat is conducted from the motor housing whose temperature becomes high to the ECU housing (the ECU heat sink) whose temperature is low.

In contrast to this, in the case of the present embodiment shown in FIG. 6B, as shown by arrows (i) and (j), both of parts of the heat generated in the MOSFET 12 and generated in the armature winding 7e of the electric motor 7 are conducted to the second metal circuit board 15 that is set in the middle of them, and further conducted, as shown by arrows (k) and (l), to the motor housings 7a, 7b and the ECU housing (the ECU heat sink) 8a from the second metal circuit board 15. The residual of the heat generated in the armature winding 7e and the motor relays 18u, 18v is conducted to the gear 9 through the motor housings 7a, 7b as shown by arrows (m) and (n). As shown by an arrow (o), the heat is conducted to the motor housings 7a, 7b from the ECU housing (the ECU heat sink) 8a whose temperature becomes high.

The heat generation amount of the MOSFET 12 is large, and the MOSFET 12 has a limitation on self-heat radiation. Therefore, if the heat generated in the armature winding 7e of the electric motor 7 and the motor relays 18u, 18v is conducted to the MOSFET 12, excessive heat is accumulated in the MOSFET 12. Further, if an amount of the heat accumulated in the MOSFET 12 increases, a fail-safe function of the electric power steering is performed. This decreases a driving force of the electric motor and gradually decreases the steering assist force, and finally stops the electric motor, which causes a heavy steering operation.

In the present embodiment, since the heat generated in the armature winding 7e of the electric motor 7 and the motor relays 18u, 18v is conducted to the motor housings 7a, 7b and the ECU housing (the ECU heat sink) 8a through the second metal circuit board 15, the heat conduction to the MOSFET 12 is suppressed. This therefore prevents the fail-safe function of the electric power steering from being performed.

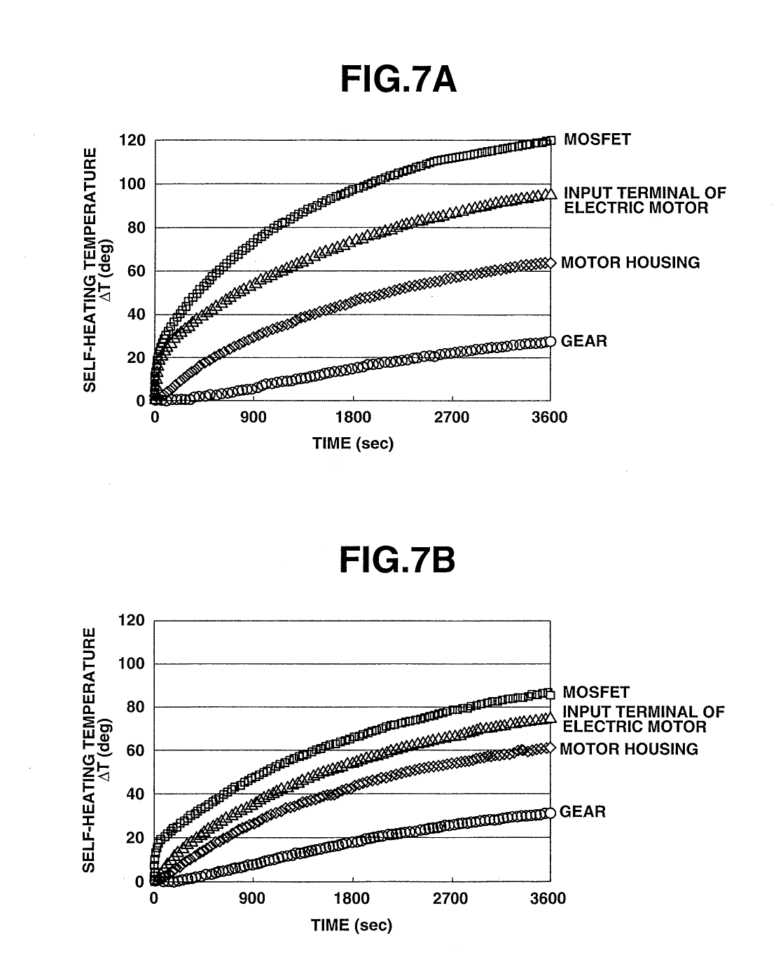

A relationship (temperature change) between time and temperature of each element or component by the heat generated in the MOSFET 12 as the semiconductor switch, the armature winding 7e of the electric motor 7 and the motor relays 18u, 18v is shown in FIGS. 7A and 7B. FIG. 7A is a case of the related art electric power steering system. FIG. 7B is a case of the present embodiment.

There is almost no difference between the related art electric power steering system and the present embodiment in the temperature (temperature change) of the gear and the motor housing. However, with respect to the input terminal of the electric motor and MOSFET, their temperatures of the present embodiment are lower than those of the related art electric power steering system.

In the present embodiment, although the second metal circuit board 15 is used as the current-carrying member (the conductive member), a member except the metal circuit board could be used. Further, although the second metal circuit board 15 is pressed against the motor housing 7a through the retaining member 19, the metal circuit board could be directly pressed against the motor housing 7a with a bolt. Furthermore, although the conductive member touches or is contiguous to the inner surface of the motor housing 7a, the conductive member might touch or be contiguous to an inner surface of the ECU housing 8a.

The entire contents of Japanese Patent Applications No. 2011-200058 filed on Sep. 14, 2011 and No. 2011-200059 filed on Sep. 14, 2011 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. An electric power steering system comprising:
an electric motor that is housed in a motor housing having a cylindrical portion and provides a steering assist force to a steering shaft;
a control unit that controls the electric motor, the control unit having
an ECU housing located on an opposite side to an output shaft of the electric motor in an axial direction of the motor housing;
a power conversion circuit housed in the ECU housing and having a semiconductor switch for controlling drive of the electric motor; and
a control circuit housed in the ECU housing and controlling the semiconductor switch; and
a conductive member that electrically connects an output terminal of the semiconductor switch and an input terminal of the electric motor, and
part of a metal board of the conductive member being contiguous to an inner surface of the motor housing or of the ECU housing.

2. The electric power steering system as claimed in claim 1, wherein:
the conductive member is contiguous to the inner surface of the motor housing.

3. The electric power steering system as claimed in claim 1, further comprising:
a retaining member that is formed from insulating material and retains the conductive member, and wherein
as the conductive member, a metal circuit board is used, and
by fixing the retaining member to either one housing of the motor housing or the ECU housing, the metal circuit board is pressed against the inner surface of the one housing with the metal circuit board sandwiched between the retaining member and the one housing.

4. An electric power steering system comprising:
an electric motor that is housed in a motor housing having a cylindrical portion and provides a steering assist force to a steering shaft;
a control unit that controls the electric motor, the control unit having
an ECU housing located on an opposite side to an output shaft of the electric motor in an axial direction of the motor housing;
a power conversion circuit housed in the ECU housing and having a semiconductor switch for controlling drive of the electric motor; and
a control circuit housed in the ECU housing and controlling the semiconductor switch;
a conductive member that electrically connects an output terminal of the semiconductor switch and an input terminal of the electric motor; and
a motor relay that is configured by a semiconductor element and applies power to the electric motor or stops the power, and
part of a metal board of the conductive member being contiguous to an inner surface of the motor housing, and
the motor relay being mounted on the conductive member.

5. The electric power steering system as claimed in claim 4, further comprising:
a retaining member that is formed from insulating material and retains the conductive member, and wherein
as the conductive member, a metal circuit board is used, and
by fixing the retaining member to the motor housing, the metal circuit board is pressed against the motor housing with the metal circuit board sandwiched between the retaining member and the motor housing.

6. The electric power steering system as claimed in claim 4, wherein:
the electric motor has a cantilever structure in which one end at an output shaft side of the motor housing is joined to a steering mechanism.
